(19) United States
(12) Patent Application Publication
(10) Pub. No.: US 2018/0166035 A1
(43) Pub. Date: Jun. 14, 2018

(54) GOA CIRCUIT AND LIQUID CRYSTAL DISPLAY DEVICE

(71) Applicant: SHENZHEN CHINA STAR OPTOELECTRONICS TECHNOLOGY CO., LTD., Guangdong (CN)

(72) Inventor: Xiaoyu HUANG, Guangdong (CN)

(21) Appl. No.: 15/306,890

(22) PCT Filed: Mar. 31, 2016
(86) PCT No.: PCT/CN2016/077993

§ 371 Date: Oct. 26, 2016

(30) Foreign Application Priority Data
Feb. 18, 2016 (CN) 201610089517.1

(51) Int. Cl. G09G 3/36

(52) U.S. Cl. CPC G09G 3/3677; G09G 2320/0257

(57) ABSTRACT

The present invention provides a GOA circuit and a liquid crystal display device. The gate drive circuit includes: a GOA unit and an output control unit. The output control unit includes a first control branch utilized for controlling the gate drive module to output a switch scan voltage which is associated with the initial scan voltage; and a second control branch utilized for controlling the gate drive module to output a switch scan voltage which is not associated with the initial scan voltage.

### BACKGROUND OF THE INVENTION

### Field of Invention

The present invention relates to a display field, and more particularly to a GOA circuit and a liquid crystal display device.

### Description of Prior Art

With the continuous development of thin film transistor liquid crystal display devices (TFT-LCDs), the TFT-LCDs have become an important display platform in IT and video products, and thus users have higher and higher demand for the TFT-LCDs. To meet requirements of narrow frame and low cost, the GOA (Gate On Array) technology in which gate drive chips are integrated in an array substrate has been developed rapidly.

In a practical drive process of a TFT-LCD, a display function is implemented by applying voltages to two sides of a display panel to drive liquid crystals to be rotated. However, when the TFT-LCD is turned off, charge residues are at the two sides of the display panel since discharges are not complete. Accordingly, when the TFT-LCD is turned on after being turned off, an image residue appears (i.e. power-off residue image).

Currently, in a conventional architecture, G-COF solves the problem of the power-off residue image via an XAO function (Output All On, gate outputs are all turned on). However, in the GOA technology, the gate drive chips are integrated in the array substrate, and thus the problem of the power-off residue image cannot be solved via the XAO function. The residue image exists in the conventional liquid crystal display device in the GOA technology, and the display effect is decreased.

Consequently, there is a need to provide a GOA circuit and a liquid crystal display device to solve the problem which exists in the prior art.

### SUMMARY OF THE INVENTION

An objective of the present invention is to provide a GOA circuit and a liquid crystal display device to solve the technical problem that the residue image exists in the conventional liquid crystal display device in the GOA technology and the display effect is decreased.

To solve the above-mentioned technical problem, the present invention provides a GOA circuit which comprises multiple gate drive modules utilized for inputting scan signals to scan lines. Each of the gate drive modules comprising:

A GOA unit utilized for providing an initial scan voltage; and

An output control unit connected to the GOA unit, the output control unit utilized for eliminating a residue image of a liquid crystal display device and comprising:

A first control branch utilized for controlling the gate drive module to output a switch scan voltage which is associated with the initial scan voltage; the first control branch comprising a first thin film transistor; and

A second control branch utilized for controlling the gate drive module to output a switch scan voltage which is not associated with the initial scan voltage; the second control branch comprising a second thin film transistor;

Wherein inputs of the output control unit comprise a control voltage and a high-level voltage supply; the control voltage includes a high level and a low level; the first thin film transistor is a PNP type thin film transistor, and the second thin film transistor is an NPN type thin film transistor.

In the GOA circuit of the present invention, a control terminal of the first thin film transistor and a control terminal of the second thin film transistor are connected to the control voltage. An input terminal of the first thin film transistor is connected to the initial scan voltage. An output terminal of the first thin film transistor is connected to an output terminal of the second thin film transistor. The output terminal of the first thin film transistor is connected to one of the scan lines, and an input terminal of the second thin film transistor is connected to the high-level power supply.

In the GOA circuit of the present invention, when the gate drive module outputs the switch scan voltage which is associated with the initial scan voltage, the control voltage is at the low level and the switch scan voltage is equal to the initial scan voltage;

When the gate drive module outputs the switch scan voltage which is not associated with the initial scan voltage, the control voltage is at the high level and the switch scan voltage is equal to a voltage value of the high-level power supply.

In the GOA circuit of the present invention, when the gate drive module outputs the switch scan voltage which is associated with the initial scan voltage, the first thin film transistor is turned on and the second thin film transistor is turned off;

When the gate drive module outputs the switch scan voltage which is not associated with the initial scan voltage, the first thin film transistor is turned off and the second thin film transistor is turned on.

To solve the above-mentioned technical problem, the present invention provides a GOA circuit which comprises multiple gate drive modules utilized for inputting scan signals to scan lines. Each of the gate drive modules comprising:

A GOA unit utilized for providing an initial scan voltage; and

An output control unit connected to the GOA unit, the output control unit utilized for eliminating a residue image of a liquid crystal display device and comprising:

A first control branch utilized for controlling the gate drive module to output a switch scan voltage which is associated with the initial scan voltage; and

A second control branch utilized for controlling the gate drive module to output a switch scan voltage which is not associated with the initial scan voltage.

In the GOA circuit of the present invention, inputs of the output control unit comprise a control voltage and a high-level voltage supply;

The first control branch comprises a first thin film transistor, and the second control branch comprises a second thin film transistor;

A control terminal of the first thin film transistor and a control terminal of the second thin film transistor are connected to the control voltage. An input terminal of the first thin film transistor is connected to the initial scan voltage. An output terminal of the first thin film transistor is connected to an output terminal of the second thin film transistor. The output terminal of the first thin film transistor is connected to one of the scan lines. An input terminal of the second thin film transistor is connected to the high-level power supply.

In the GOA circuit of the present invention, the first thin film transistor is a PNP type thin film transistor, and the second thin film transistor is an NPN type thin film transistor.

In the GOA circuit of the present invention, the control voltage includes a high level and a low level;

When the gate drive module outputs the switch scan voltage which is associated with the initial scan voltage, the control voltage is at the low level and the switch scan voltage is equal to the initial scan voltage;

When the gate drive module outputs the switch scan voltage which is not associated with the initial scan voltage, the control voltage is at the high level and the switch scan voltage is equal to a voltage value of the high-level power supply.

In the GOA circuit of the present invention, when the gate drive module outputs the switch scan voltage which is associated with the initial scan voltage, the first thin film transistor is turned on and the second thin film transistor is turned off;

When the gate drive module outputs the switch scan voltage which is not associated with the initial scan voltage, the first thin film transistor is turned off and the second thin film transistor is turned on.

The present invention further provides a liquid crystal display device which comprises:

A GOA circuit, comprising:

Multiple gate drive modules utilized for inputting scan signals to scan lines, each of the gate drive modules comprising:

A GOA unit utilized for providing an initial scan voltage; and

An output control unit connected to the GOA unit, the output control unit utilized for eliminating a residue image of a liquid crystal display device and comprising:

A first control branch utilized for controlling the gate drive module to output a switch scan voltage which is associated with the initial scan voltage; and

A second control branch utilized for controlling the gate drive module to output a switch scan voltage which is not associated with the initial scan voltage.

In the liquid crystal display device of the present invention, inputs of the output control unit comprise a control voltage and a high-level voltage supply;

The first control branch comprises a first thin film transistor, and the second control branch comprises a second thin film transistor;

A control terminal of the first thin film transistor and a control terminal of the second thin film transistor are connected to the control voltage; an input terminal of the first thin film transistor is connected to the initial scan voltage; an output terminal of the first thin film transistor is connected to an output terminal of the second thin film transistor, the output terminal of the first thin film transistor is connected to one of the scan lines, and an input terminal of the second thin film transistor is connected to the high-level power supply.

In the liquid crystal display device of the present invention, the first thin film transistor is a PNP type thin film transistor, and the second thin film transistor is an NPN type thin film transistor.

In the liquid crystal display device of the present invention, the control voltage includes a high level and a low level;

When the gate drive module outputs the switch scan voltage which is associated with the initial scan voltage, the control voltage is at the low level and the switch scan voltage is equal to the initial scan voltage;

When the gate drive module outputs the switch scan voltage which is not associated with the initial scan voltage, the control voltage is at the high level and the switch scan voltage is equal to a voltage value of the high-level power supply.

In the liquid crystal display device of the present invention, when the gate drive module outputs the switch scan voltage which is associated with the initial scan voltage, the first thin film transistor is turned on and the second thin film transistor is turned off;

When the gate drive module outputs the switch scan voltage which is not associated with the initial scan voltage, the first thin film transistor is turned off and the second thin film transistor is turned on.

In the GOA circuit and the liquid crystal display device of the present invention, the output control units are added to the outputs of the current GOA units. When the liquid crystal display device is turned off, the voltages which are inputted to the scan lines are all at a high level and the liquid crystal display device can be discharged completely. Accordingly, the phenomenon of the residue image is eliminated, and the display effect is increased.

### BRIEF DESCRIPTION OF THE DRAWINGS

FIG. 1 is a structure of a gate drive module in accordance with the present invention; and

FIG. 2 is a circuit diagram of an output control unit in accordance with the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto. In the drawings, structure-like elements are labeled with like reference numerals.

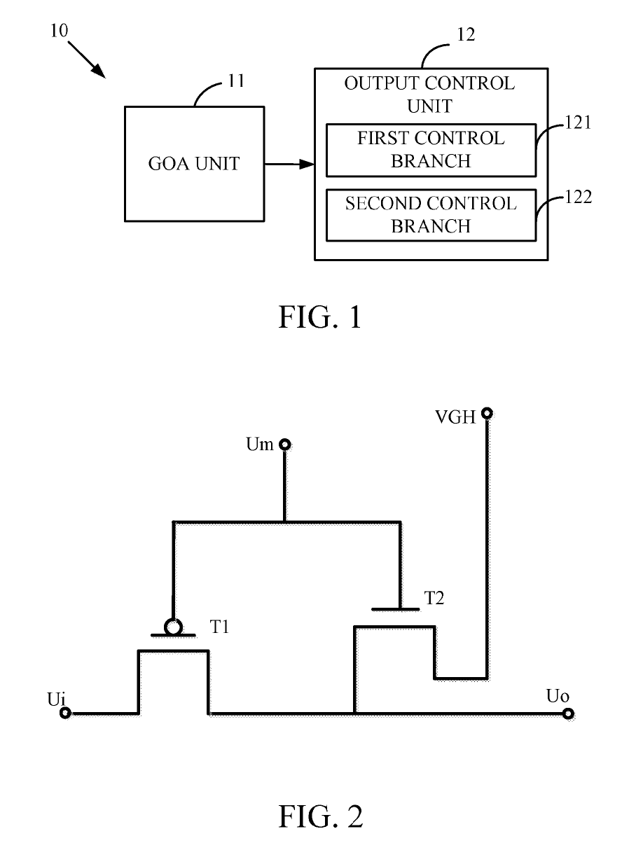

Please refer to FIG. 1. FIG. 1 is a structure of a gate drive module in accordance with the present invention.

A GOA circuit of the present invention comprises multiple gate drive modules. The gate drive modules are utilized for inputting scan signals to scan lines. A number of the gate drive modules is equal to a number of the scan lines. As shown in FIG. 1, the gate drive module 10 comprises a GOA unit 11 and an output control unit 12.

The GOA unit 11 is utilized for providing an initial scan voltage. The output control unit 12 is connected to the GOA unit 11 and utilized for eliminating a residue image of a liquid crystal display device. The output control unit comprises a first control branch 121 and a second control branch 122. The first control branch 121 is utilized for controlling the gate drive module to output a switch scan voltage which is associated with the initial scan voltage, and the second control branch 122 is utilized for controlling the gate drive module to output a switch scan voltage which is not associated with the initial scan voltage.

Specifically, as shown in FIG. 2, inputs of the output control unit 12 comprise a control voltage Um and a high-level voltage supply. The control voltage Um includes a high level and a low level.

The first control branch comprises a first thin film transistor T1, and the second control branch comprises a second thin film transistor T2.

A control terminal of the first thin film transistor T1 and a control terminal of the second thin film transistor T2 are connected to the control voltage Um. An input terminal of the first thin film transistor T1 is connected to the initial scan voltage Ui. An output terminal of the first thin film transistor T1 is connected to an output terminal of the second thin film transistor T2, and the output terminal of the first thin film transistor T1 is connected to a scan line (not shown). That is, the output control unit 12 outputs the switch scan voltage Uo. An input terminal of the second thin film transistor T2 is connected to the high-level power supply. A voltage value VGH of the high-level power supply is, for example, 33V.

The first thin film transistor T1 is a PNP type thin film transistor, and the second thin film transistor T2 is an NPN type thin film transistor.

In conjunction with FIG. 1, when the liquid crystal display device is operated normally, the control voltage Um is at a low level (e.g. 0V), T1 is turned on and T2 is turned off. That is, the first control branch 121 is in a connection state, while the second thin film transistor T2 is in a disconnection state. Accordingly, the voltage Ui which is inputted to the input of T1 can be outputted to the scan line. The voltage VGH of the high-level power supply cannot be outputted to the scan line. The switch scan voltage Uo which is outputted by the output control unit 12 is equal to the initial scan voltage Ui. That is, the switch scan voltage Uo which is outputted by the gate drive module is associated with the initial scan voltage Ui.

When it is detected that the liquid crystal display device is turned off, the control voltage Um is at a high level (e.g. 33V), T1 is turned off and T2 is turned on. That is, the first control branch 121 is in a disconnection state, while the second thin film transistor T2 is in a connection state. Accordingly, the voltage Ui which is inputted to the input of T1 cannot be outputted to the scan line. The voltage VGH of the high-level power supply can be outputted to the scan line. The switch scan voltage Uo which is outputted by the output control unit 12 is equal to the voltage VGH of the high-level power supply (e.g. 33V). That is, the switch scan voltage Uo which is outputted by the gate drive module is not associated with the initial scan voltage Ui.

When the liquid crystal display device is operated normally, an output voltage of the GOA unit 11 is inputted to the scan line. When the liquid crystal display device is turned off, the high-level voltage is inputted to the scan line to continuously make control terminals of thin film transistors corresponding to pixel units be in a turned-on state, thereby ensuring that voltages which are inputted from data lines are released. The phenomenon of the power-off residue image is eliminated, and the display effect is increased.

In the GOA circuit of the present invention, the output control units are added to the outputs of the current GOA units. When the liquid crystal display device is turned off, the voltages which are inputted to the scan lines are all at a high level and the liquid crystal display device can be discharged completely. Accordingly, the phenomenon of the residue image is eliminated, and the display effect is increased.

The present invention further provides a liquid crystal display device which comprises an array substrate, a color filter substrate. The array substrate comprises a plurality of data lines, a plurality of scan lines, and a plurality of pixel units defined by the data lines and the scan lines. The array substrate further comprises a GOA circuit. The GOA circuit comprises multiple gate drive modules. The gate drive modules are utilized for inputting scan signals to the scan lines. A number of the gate drive modules is equal to a number of the scan lines. As shown in FIG. 1, the gate drive module 10 comprises the GOA unit 11 and the output control unit 12.

The GOA unit 11 is utilized for providing an initial scan voltage. The output control unit 12 is connected to the GOA unit 11 and utilized for eliminating a residue image of a liquid crystal display device. The output control unit comprises a first control branch 121 and a second control branch 122. The first control branch 121 is utilized for controlling the gate drive module to output a switch scan voltage which is associated with the initial scan voltage, and the second control branch 122 is utilized for controlling the gate drive module to output a switch scan voltage which is not associated with the initial scan voltage.

Specifically, as shown in FIG. 2, inputs of the output control unit 12 comprise a control voltage Um and a high-level voltage supply. The control voltage Um includes a high level and a low level.

The first control branch comprises a first thin film transistor T1, and the second control branch comprises a second thin film transistor T2.

A control terminal of the first thin film transistor T1 and a control terminal of the second thin film transistor T2 are connected to the control voltage Um. An input terminal of the first thin film transistor T1 is connected to the initial scan voltage Ui. An output terminal of the first thin film transistor T1 is connected to an output terminal of the second thin film transistor T2, and the output terminal of the first thin film transistor T1 is connected to a scan line (not shown). That is, the output control unit 12 outputs the switch scan voltage Uo. An input terminal of the second thin film transistor T2 is connected to the high-level power supply. A voltage value VGH of the high-level power supply is, for example, 33V.

The first thin film transistor T1 is a PNP type thin film transistor, and the second thin film transistor T2 is an NPN type thin film transistor.

In conjunction with FIG. 1, when the liquid crystal display device is operated normally, the control voltage Um is at a low level (e.g. 0V), T1 is turned on and T2 is turned off. That is, the first control branch 121 is in a connection state, while the second thin film transistor T2 is in a disconnection state. Accordingly, the voltage Ui which is inputted to the input of T1 can be outputted to the scan line. The voltage VGH of the high-level power supply cannot be outputted to the scan line. The switch scan voltage Uo which is outputted by the output control unit 12 is equal to the initial scan voltage Ui. That is, the switch scan voltage Uo which is outputted by the gate drive module is associated with the initial scan voltage Ui.

When it is detected that the liquid crystal display device is turned off, the control voltage Um is at a high level (e.g. 33V), T1 is turned off and T2 is turned on. That is, the first control branch 121 is in a disconnection state, while the second thin film transistor T2 is in a connection state. Accordingly, the voltage Ui which is inputted to the input of T1 cannot be outputted to the scan line. The voltage VGH of the high-level power supply can be outputted to the scan line. The switch scan voltage Uo which is outputted by the output control unit 12 is equal to the voltage VGH of the high-level power supply (e.g. 33V). That is, the switch scan voltage Uo which is outputted by the gate drive module is not associated with the initial scan voltage Ui.

When the liquid crystal display device is operated normally, an output voltage of the GOA unit 11 is inputted to the scan line. When the liquid crystal display device is turned off, the high-level voltage is inputted to the scan line to continuously make control terminals of thin film transistors corresponding to pixel units be in a turned-on state, thereby ensuring that voltages which are inputted from data lines are released. The phenomenon of the power-off residue image is eliminated, and the display effect is increased.

In the liquid crystal display device of the present invention, the output control units are added to the outputs of the current GOA units. When the liquid crystal display device is turned off, the voltages which are inputted to the scan lines are all at a high level and the liquid crystal display device can be discharged completely. Accordingly, the phenomenon of the residue image is eliminated, and the display effect is increased.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A GOA circuit, comprising multiple gate drive modules utilized for inputting scan signals to scan lines, each of the gate drive modules comprising:
a GOA unit utilized for providing an initial scan voltage; and
an output control unit connected to the GOA unit, the output control unit utilized for eliminating a residue image of a liquid crystal display device and comprising:
a first control branch utilized for controlling the gate drive module to output a switch scan voltage which is associated with the initial scan voltage; the first control branch comprising a first thin film transistor; and
a second control branch utilized for controlling the gate drive module to output a switch scan voltage which is not associated with the initial scan voltage; the second control branch comprising a second thin film transistor;
wherein inputs of the output control unit comprise a control voltage and a high-level voltage supply; the control voltage includes a high level and a low level; the first thin film transistor is a PNP type thin film transistor, and the second thin film transistor is an NPN type thin film transistor.

2. The GOA circuit of claim 1, wherein a control terminal of the first thin film transistor and a control terminal of the second thin film transistor are connected to the control voltage; an input terminal of the first thin film transistor is connected to the initial scan voltage; an output terminal of the first thin film transistor is connected to an output terminal of the second thin film transistor, the output terminal of the first thin film transistor is connected to one of the scan lines, and an input terminal of the second thin film transistor is connected to the high-level power supply.

3. The GOA circuit of claim 1, wherein when the gate drive module outputs the switch scan voltage which is associated with the initial scan voltage, the control voltage is at the low level and the switch scan voltage is equal to the initial scan voltage;
when the gate drive module outputs the switch scan voltage which is not associated with the initial scan voltage, the control voltage is at the high level and the switch scan voltage is equal to a voltage value of the high-level power supply.

4. The GOA circuit of claim 1, wherein when the gate drive module outputs the switch scan voltage which is associated with the initial scan voltage, the first thin film transistor is turned on and the second thin film transistor is turned off;
when the gate drive module outputs the switch scan voltage which is not associated with the initial scan voltage, the first thin film transistor is turned off and the second thin film transistor is turned on.

5. A GOA circuit, comprising multiple gate drive modules utilized for inputting scan signals to scan lines, each of the gate drive modules comprising:
a GOA unit utilized for providing an initial scan voltage; and
an output control unit connected to the GOA unit, the output control unit utilized for eliminating a residue image of a liquid crystal display device and comprising:
a first control branch utilized for controlling the gate drive module to output a switch scan voltage which is associated with the initial scan voltage; and
a second control branch utilized for controlling the gate drive module to output a switch scan voltage which is not associated with the initial scan voltage.

6. The GOA circuit of claim 5, wherein inputs of the output control unit comprise a control voltage and a high-level voltage supply;
the first control branch comprises a first thin film transistor, and the second control branch comprises a second thin film transistor;
a control terminal of the first thin film transistor and a control terminal of the second thin film transistor are connected to the control voltage; an input terminal of the first thin film transistor is connected to the initial scan voltage; an output terminal of the first thin film transistor is connected to an output terminal of the second thin film transistor, the output terminal of the first thin film transistor is connected to one of the scan lines, and an input terminal of the second thin film transistor is connected to the high-level power supply.

7. The GOA circuit of claim 6, wherein the first thin film transistor is a PNP type thin film transistor, and the second thin film transistor is an NPN type thin film transistor.

8. The GOA circuit of claim 6, wherein the control voltage includes a high level and a low level;
when the gate drive module outputs the switch scan voltage which is associated with the initial scan voltage, the control voltage is at the low level and the switch scan voltage is equal to the initial scan voltage;
when the gate drive module outputs the switch scan voltage which is not associated with the initial scan voltage, the control voltage is at the high level and the switch scan voltage is equal to a voltage value of the high-level power supply.

9. The GOA circuit of claim 6, wherein when the gate drive module outputs the switch scan voltage which is associated with the initial scan voltage, the first thin film transistor is turned on and the second thin film transistor is turned off;
when the gate drive module outputs the switch scan voltage which is not associated with the initial scan voltage, the first thin film transistor is turned off and the second thin film transistor is turned on.

10. A liquid crystal display device, comprising:
A GOA circuit, comprising multiple gate drive modules utilized for inputting scan signals to scan lines, each of the gate drive modules comprising:
a GOA unit utilized for providing an initial scan voltage; and
an output control unit connected to the GOA unit, the output control unit utilized for eliminating a residue image of a liquid crystal display device and comprising:
a first control branch utilized for controlling the gate drive module to output a switch scan voltage which is associated with the initial scan voltage; and
a second control branch utilized for controlling the gate drive module to output a switch scan voltage which is not associated with the initial scan voltage.

11. The liquid crystal display device of claim 10, wherein inputs of the output control unit comprise a control voltage and a high-level voltage supply;
the first control branch comprises a first thin film transistor, and the second control branch comprises a second thin film transistor;
a control terminal of the first thin film transistor and a control terminal of the second thin film transistor are connected to the control voltage; an input terminal of the first thin film transistor is connected to the initial scan voltage; an output terminal of the first thin film transistor is connected to an output terminal of the second thin film transistor, the output terminal of the first thin film transistor is connected to one of the scan lines, and an input terminal of the second thin film transistor is connected to the high-level power supply.

12. The liquid crystal display device of claim 11, wherein the first thin film transistor is a PNP type thin film transistor, and the second thin film transistor is an NPN type thin film transistor.

13. The liquid crystal display device of claim 11, wherein the control voltage includes a high level and a low level;
when the gate drive module outputs the switch scan voltage which is associated with the initial scan voltage, the control voltage is at the low level and the switch scan voltage is equal to the initial scan voltage;
when the gate drive module outputs the switch scan voltage which is not associated with the initial scan voltage, the control voltage is at the high level and the switch scan voltage is equal to a voltage value of the high-level power supply.

14. The liquid crystal display device of claim 11, wherein when the gate drive module outputs the switch scan voltage which is associated with the initial scan voltage, the first thin film transistor is turned on and the second thin film transistor is turned off;
when the gate drive module outputs the switch scan voltage which is not associated with the initial scan voltage, the first thin film transistor is turned off and the second thin film transistor is turned on.
